(19) United States
(12) Patent Application Publication
(10) Pub. No.: US 2012/0206338 A1
(43) Pub. Date: Aug. 16, 2012

(54) OPERATIONAL INPUT DEVICE

(75) Inventors: Kenichi FURUKAWA, Tokyo (JP); Kensuke YAMADA, Tokyo (JP)

(73) Assignee: MITSUMI ELECTRIC CO., LTD., Tokyo (JP)

(21) Appl. No.: 13/367,422

(22) Filed: Feb. 7, 2012

(30) Foreign Application Priority Data
Feb. 10, 2011 (JP) 2011-027918
Jan. 24, 2012 (JP) 2012-012488

(51) Int. Cl. G06F 3/01

(52) U.S. Cl. 345/156

(57) ABSTRACT

An operational input device that outputs a signal corresponding to a displacement amount of an operational input, includes a coil annularly extending from a first side toward a second side; a core configured to vary the inductance of the coil by being moved within the coil along an axis of the coil by the operational input applied from the first side toward the second side; and a yoke provided at an end surface of the coil at the second side and provided with an opening at a position facing an end surface of the core at the second side.

### BACKGROUND OF THE INVENTION

1. Field of the Invention

The present invention relates to an operational input device and more specifically, to an operational input device including a core that is moved in accordance with an operational input, and capable of outputting a signal corresponding to a displacement of the core.

2. Description of the Related Art

A contactless switch device in which a switch is ON or OFF is detected by detecting whether a core or the like composed of a magnetic material is within a coil has been known (for example, see Japanese Laid-open Patent Publication No. 2001-76597).

Further, an operational input device in which an operational input applied by an operator is detected by detecting the inductance of a coil using a mechanism that the inductance of a coil varies in accordance with a displacement amount of a core has been developed, which is different from just detecting ON and OFF of a switch. It is desirable to configure the operational input device such that the detected inductance of the coil linearly varies with respect to the displacement amount of the core to obtain an accurate value. However, conventionally, it was difficult to configure the operational input device to actualize such linearity.

### SUMMARY OF THE INVENTION

The present invention is made in light of the above problems, and provides an operational input device capable of improving the linearity of the detected inductance with respect to the displacement amount of the core.

According to an embodiment, there is provided an operational input device that outputs a signal corresponding to a displacement amount of an operational input, including a coil annularly extending from a first side toward a second side; a core configured to vary the inductance of the coil by being moved within the coil along an axis of the coil by the operational input applied from the first side toward the second side; and a yoke provided at an end surface of the coil at the second side and provided with an opening at a position facing an end surface of the core at the second side.

According to the operational input device, the linearity of the detected inductance with respect to the displacement amount of the core can be improved.

### BRIEF DESCRIPTION OF THE DRAWINGS

Other objects, features and advantages of the present invention will become more apparent from the following detailed description when read in conjunction with the accompanying drawings.

FIG. 1 is a cross-sectional view showing a part of an operational input device for explaining a principle operation of the operational input device;

FIG. 2A and FIG. 2B are perspective views of a coil assembly which is an example of the operational input device;

FIG. 3 shows a set of drawings including a front elevation view, a back elevation view, a left-side view, a right-side view, a plan view and a back plan view showing the coil assembly shown in FIG. 2A;

FIG. 4 is a cross-sectional view taken along an A-A in FIG. 3;

FIG. 5 is a side view showing the coil assembly shown in FIG. 2A mounted on a surface of a substrate;

FIG. 6A is a graph showing a relationship between the detected inductance of a coil with respect to the actual displacement amount of a core moved downward within the coil;

FIG. 6B is a graph showing the rate of variation of the detected inductance of the coil with respect to the actual displacement amount of the core moved downward within the coil 2;

FIG. 7 is an exploded perspective view of an example of an operational detection device;

FIG. 8 is a cross-sectional view of the operational detection device shown in FIG. 7 at an initial state;

FIG. 9 is a cross-sectional view of the operational detection device shown in FIG. 7 when an operational input is applied such that a key is inclined;

FIG. 10 is a cross-sectional view of the operational detection device shown in FIG. 7 when an operational input is applied such that the key is horizontally moved downward;

FIG. 11 is an enlarged cross-sectional view of another example of the operational detection device shown in FIG. 7 at an initial state;

FIG. 12 is an enlarged cross-sectional view of another example of the operational detection device shown in FIG. 7 when an operational input is applied such that a key is inclined;

FIG. 13 is a front elevation view showing another example of the coil assembly shown in FIG. 2A;

FIG. 14 is an exploded perspective view of another example of an operational input device;

FIG. 15A is a cross-sectional view of the operational input device shown in FIG. 14 at an initial state; and

FIG. 15B is a cross-sectional view of the operational input device shown in FIG. 14 when an operational input is applied such that a key is inclined.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

An operational input device of the embodiment is an operational interface that outputs a signal which varies in accordance with a force applied by a hand, fingers or the like of an operator. Hereinafter, the force applied by an operator is referred to as an “operational input”. The operational input can be detected by a computer based on the signal output from the operational input device.

For example, the operational input device may be adapted to an electronic device such as a home or portable game console, a mobile terminal such as a mobile phone, a music player or the like, a personal computer, an electric appliance or the like. By operating the operational input device, in other words, by applying an operational input to the electronic device, an operator can manipulate an object such as a direction like a cursor or a pointer, a character or the like displayed on a screen shown in a display of the electronic device. Further, by applying an operational input to the electronic device, an operator can actualize a desired function of the electronic device.

Here, generally, inductance “L” (H) of an inductor such as a coil (winding) or the like can be expressed as the following equation where “K” is a coefficient, “μ” (H/m) is a magnetic permeability, “n” is the number of turns of the coil, “S” is a cross-sectional area of the coil in square meters (m²), and “d” (m) is the magnetic length of the coil.

L=Kμn²S/d

As can be understood from the equation, when the parameters, values of which depend on the shape of the coil, such as the number of turns of the coil “n” or the cross-sectional area of the coil in square meters “S” are fixed, the inductance “L” can be varied by varying the magnetic permeability “μ” or by varying the magnetic length “d”.

According to this embodiment, the operational input device uses the variation of the inductance.

The operational input device accepts a force applied by an operator as an operational input from a first side toward a second side along a Z-axis direction of the orthogonal coordinate system defined by X-axis, Y-axis and Z-axis. The Z-axis direction means a direction which is in parallel relationship with Z-axis.

The operational input device includes a variance member such as a core configured to vary the inductance of a coil by being moved within the coil along the Z-axis direction by the operational input applied from the first side toward the second side. The operational input device detects the operational input by detecting the movement of the variance member that varies in accordance with the operational input applied by the operator, based on a predetermined signal that varies in accordance with the inductance value.

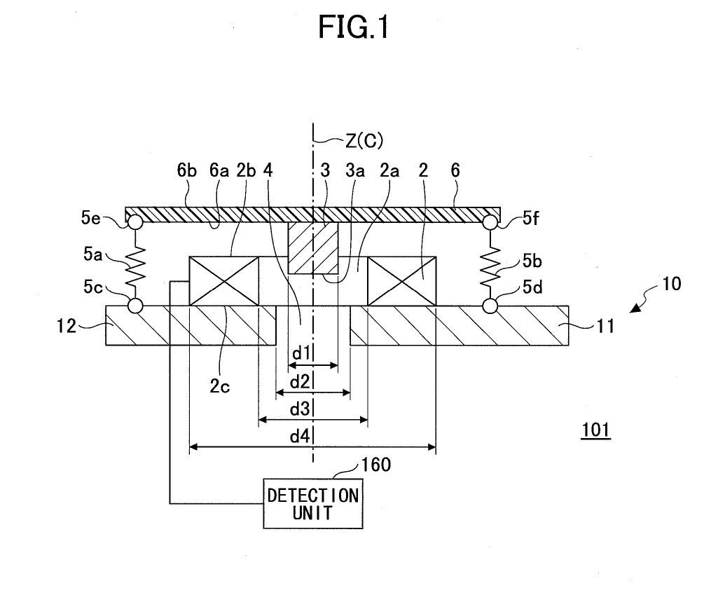

FIG. 1 is a cross-sectional view showing a part of an operational input device 101 for explaining a principle operation of the operational input device 101.

The operational input device 101 includes an operational input unit 6, a coil 2, a core 3, a lower yoke 10 and a detection unit 160.

FIG. 1 shows an initial state of the operational input device 101 when an operational input is not applied to an operational surface 6b (upper surface in FIG. 1) of the operational input unit 6.

Each of the components of the operational input device 101 is explained.

The coil 2 is formed by cylindrically winding a conductive wire. The coil 2 may have a cylindrical tubular shape or other tubular shapes such as an angular tubular shape or the like. The coil 2 is provided with a hollow portion 2a formed at its center. The coil 2 outputs a signal corresponding to a displacement amount of the core 3. This will be explained later in detail.

The core 3 is a variance member configured to vary the inductance of the coil 2 by being moved within the hollow portion 2a of the coil 2 along the center axis C of the coil 2 by the operational input from a first side (upper side in FIG. 1) toward a second side (lower side in FIG. 1). The core 3 may be composed of a magnetic material. When the coil 2 has a cylindrical tubular shape, the core 3 may have a cylindrical column shape as well, and when the coil 2 has an angular tubular shape, the core 3 may have an angular column shape as well.

The core 3 is provided at the center of a lower surface 6a of the operational input unit 6 and moves with the operational input unit 6. The operational input unit 6 is provided at the first side where the force (operational input) is applied from by an operator. The lower surface 6a of the operational input unit 6 faces an upper surface 2b of the coil 2. The force of the operator is directly or indirectly applied to the operational surface 6b of the operational input unit 6.

When the force of the operator is applied to the operational input unit 6, the inductance of the coil 2 varies as the position of the core 3 within the hollow portion 2a of the coil 2 varies.

The core 3 and the operational input unit 6 are supported by support members 5a and 5b such that the positional relationship between a lower end surface 3a of the core 3 and the upper surface 2b of the coil 2 can be resiliently varied along the center axis C. The support member 5a is attached at points 5e and 5c of the operational input unit 6 and the lower yoke 10 and the support member 5a is attached at points 5f and 5d of the operational input unit 6 and the lower yoke 10, respectively. The support members 5a and 5b may be composed of a rubber member, a sponge member, a spring member, or a cylinder in which air or oil is filled, for example. For example, by adopting the spring member, the structure can be lightened or simplified. Further, by adopting the rubber member, the operational input unit 6 can be insulated from the lower yoke 10. Further, alternatively, the support members 5a and 5b may be a viscous member having viscosity.

The lower yoke 10 is placed at a lower surface 2c side of the coil 2. The lower yoke 10 is provided with an opening 4 at a position facing the lower end surface 3a of the core 3. The lower yoke 10 is composed of a magnetic material formed in a plate shape.

In this embodiment, the lower yoke 10 is composed of a first yoke 11 and a second yoke 12. The first yoke 11 and the second yoke 12 are separately provided in a direction perpendicular to the Z-axis direction (center axis C) to have a space between the first yoke 11 and the second yoke 12. In other words, the opening 4 is provided between the first yoke 11 and the second yoke 12 to be in communication with the hollow portion 2a of the coil 2. The center axis of the opening 4 in the Z-axis direction may be coaxial with the center axis C of the coil 2.

Further, the first yoke 11 and the second yoke 12 may be composed of a material whose relative magnetic permeability is higher than 1. The first yoke 11 and the second yoke 12 may be composed of a material whose relative magnetic permeability is greater than or equal to 1.001. The material for composing the first yoke 11 and the second yoke 12 may be steel plates (the relative magnetic permeability of which is 5000).

The detection unit 160 electrically detects the variation of the inductance of the coil 2 corresponding to an analog displacement amount of the core 3 that continuously varies (in other words, a displacement amount of the operational input unit 6 varied by an operational input), and outputs a detection signal based on the detected variation of the inductance of the coil 2. The detection unit 160 may be composed of a detection circuit mounted on a substrate (not shown in the drawings).

The detection unit 160 may detect a physical value that varies in accordance with the variation of the inductance of the coil 2, and output the detected physical value as an equivalent value of the displacement amount of the core 3, for example. Alternatively, the detection unit 160 may detect a physical value that varies in accordance with the variation of the inductance of the coil 2, calculate the inductance of the coil 2 based on the detected physical value and output the calculated inductance as an equivalent value of the displacement amount of the core 3, for example. Further, alternatively, the detection unit 160 may calculate the displacement amount of the core 3 based on the detected physical value or the calculated inductance and output the calculated displacement amount of the core 3.

Concretely, the detection unit 160 may have the coil 2 generate a signal that varies in accordance with the inductance (magnitude) of the coil 2 by supplying a pulse signal to the coil 2 and detect the variation of the inductance of the coil 2 based on the signal.

For example, when an operational input is applied to the operational input unit 6 to push the operational input unit 6 downward, the displacement amount of the core 3 in a downward direction within the hollow portion 2a of the coil 2 increases. When the displacement amount of the core 3 in the downward direction increases, the magnetic permeability around the coil 2 increases to increase the inductance of the coil 2. As the inductance of the coil 2 increases, the amplitude of a pulse voltage generated at the ends of the coil 2 by supplying a pulse signal to the coil 2, becomes greater. Therefore, in this case, the detection unit 160 may detect the amplitude of the pulse voltage as the physical value that varies in accordance with the variation of the inductance of the coil 2 and output the detected amplitude of the pulse voltage as the equivalent value of the displacement amount of the core 3.

Further, alternatively, the detection unit 160 may calculate the inductance of the coil 2 based on the detected amplitude of the pulse voltage and output the calculated inductance as the equivalent value of the displacement of the core 3.

Further, as the inductance of the coil 2 increases, the slope of a waveform of a pulse current that flows through the coil 2 by supplying the pulse signal, becomes moderate. Therefore, in this case, the detection unit 160 may detect the slope as the physical value that varies in accordance with the variation of the inductance of the coil 2 and output the detected slope as the equivalent value of the displacement amount of the core 3.

Further, alternatively, the detection unit 160 may calculate the inductance of the coil 2 based on the detected slope and output the calculated inductance as the equivalent value of the displacement amount of the core 3.

As described above with reference to FIG. 1, the lower yoke 10 provided at the lower surface 2c side of the coil 2 is composed of the first yoke 11 and the second yoke 12 which are separately provided in the direction perpendicular to the Z-axis direction (center axis C) to have the space therebetween such that the opening 4 is formed at the position facing the lower end surface 3a of the core 3. With this structure, the magnetic connection between the core 3 and the first yoke 11 and the second yoke 12 of the lower yoke 11 can be suppressed by the opening 4, and the linearity of the detected inductance of the coil 2 with respect to the displacement amount of the operational input unit 6 and the core 3 can be improved.

For example, if the opening 4 is not provided at the lower yoke 10, when the gap between the core 3 and the lower yoke 10 becomes zero or close to zero, the core 3 is magnetically connected with the lower yoke 10 so that the inductance of the coil 2 rapidly increases. As a result, the linearity of the detected inductance of the coil 2 with respect to the displacement amount of the core 3 (and the operational input unit 6) becomes bad when the displacement amount of the core 3 becomes greater.

However, according to the operational input device 101 as shown in FIG. 1 where the lower yoke 10 is provided with the opening 4, even when the gap between the core 3 and the lower yoke 10 becomes zero or close to zero, rapid increase of the detected inductance of the coil 2 can be suppressed. As a result, the linearity of the detected inductance of the coil 2 with respect to the displacement amount of the core 3 among the whole displacement range of the operational input unit 6 and the core 3, can be improved. With this, an error can be prevented in which a predetermined detection unit detects that the displacement amount of the core 3 is rapidly increased at a point just before it reaches the maximum displacement amount even though the actual displacement amount of the core 3 is increased at a constant value. The predetermined detection unit may be the detection unit 160 or another electronic device that receives a signal output from the detection unit 160. As a result, accuracy of the operation by the operator can be improved.

The opening 4 of the lower yoke 10 may be formed to be larger than the dimension of the lower end surface 3a in order to avoid a magnetic connection between the core 3 and the lower yoke 10. In other words, the opening 4 of the lower yoke 10 may be formed to be large enough so that the core 3 is capable of being inserted within the opening 4 of the lower yoke 10. With this size, the linearity of the detected inductance of the coil 2 with respect to the displacement amount of the core 3 can be improved. Further, with this size, the detection sensitivity of the self-inductance can be improved.

For example, the opening width d2 of the opening 4 (in other words, the opening diameter or the width in the direction perpendicular to the center axis C) may be greater than or equal to the outer diameter d1 of the core 3. With this size, the linearity of the detected inductance of the coil 2 with respect to the displacement amount of the core 3 can be improved.

Further, the opening width d2 of the opening 4 may be less than or equal to the outer diameter d4 of the coil 2. With this size, the detection sensitivity of the self-inductance of the coil 2 can be improved.

Further, for example, as shown in FIG. 1, the opening width d2 of the opening 4 may be less than or equal to the inner diameter d3 of the coil 2. Further, alternatively, the opening width d2 of the opening 4 may be greater than or equal to the inner diameter d3 of the coil 2.

The core 3 may not be moved to have the lower end surface 3a of the core 3 being inserted into the opening 4 even though the opening 4 is formed large enough so that the core 3 is capable of being inserted within the opening 4.

When having the opening width d2 of the opening 4 greater than or equal to the outer diameter d1 of the core 3, even when the core 3 is moved to the level of the first yoke 11 and the second yoke 12, the core 3 does not touch the first yoke 11 and the second yoke 12. Therefore, the displacement range where the detected inductance of the coil 2 linearly varies with respect to the displacement amount of the core 3 can be widened.

Further, when having the opening width d2 of the opening 4 less than or equal to the outer diameter d4 of the coil 2 (preferably, less than or equal to the inner diameter d3 of the coil 2), the dimension of the first yoke 11 and the second yoke 12 can be increased to increase the absolute value of the detected inductance of the coil 2 and the detection sensitivity for the displacement amount of the operational input unit 6 and the core 3 can be improved.

The outer diameter d1 of the core 3, the opening width d2 of the opening 4, the inner diameter d3 of the coil 2 and the outer diameter d4 of the coil 2 may be the maximum size of the corresponding components in the direction perpendicular to the center axis C (Z-axis direction, in the direction parallel to the X-axis direction or the Y-axis direction). When the core 3 has a shape different from a cylindrical column shape, the outer diameter d1 may be the maximum outer size of the core 3 in the direction perpendicular to the center axis C. When the coil 2 has a shape different from a cylindrical tubular shape, the inner diameter d3 may be the maximum inner size of the coil 2 in the direction perpendicular to the center axis C and the outer diameter d4 may be the maximum outer size of the coil 2 in the direction perpendicular to the center axis C.

The operational input device of the embodiment is further explained in detail.

### (Coil Assembly)

In this embodiment, the case where the operational input device is a coil assembly is explained.

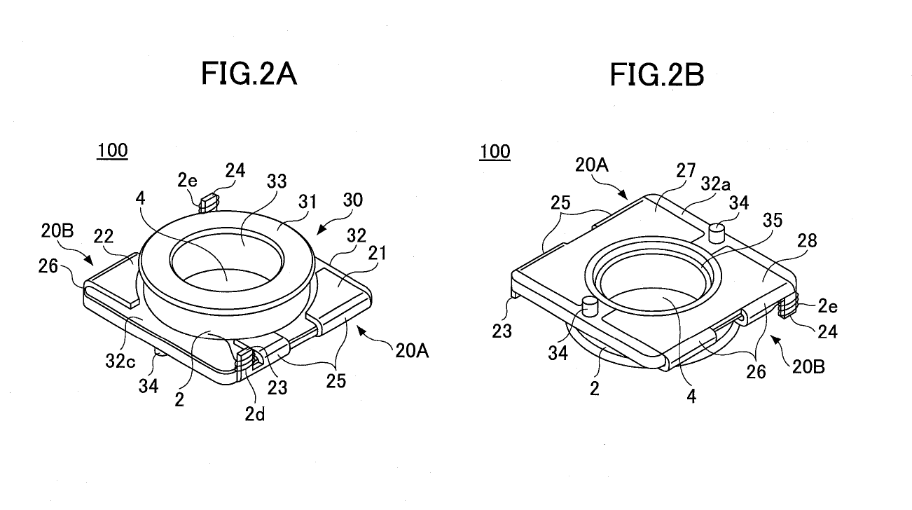

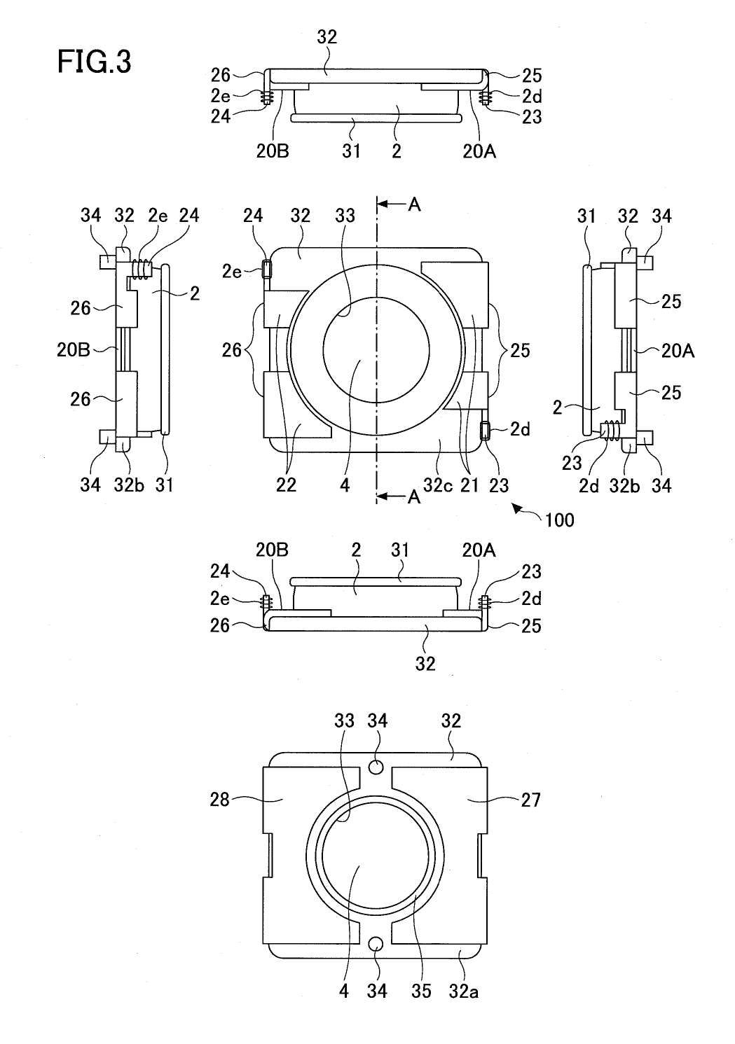

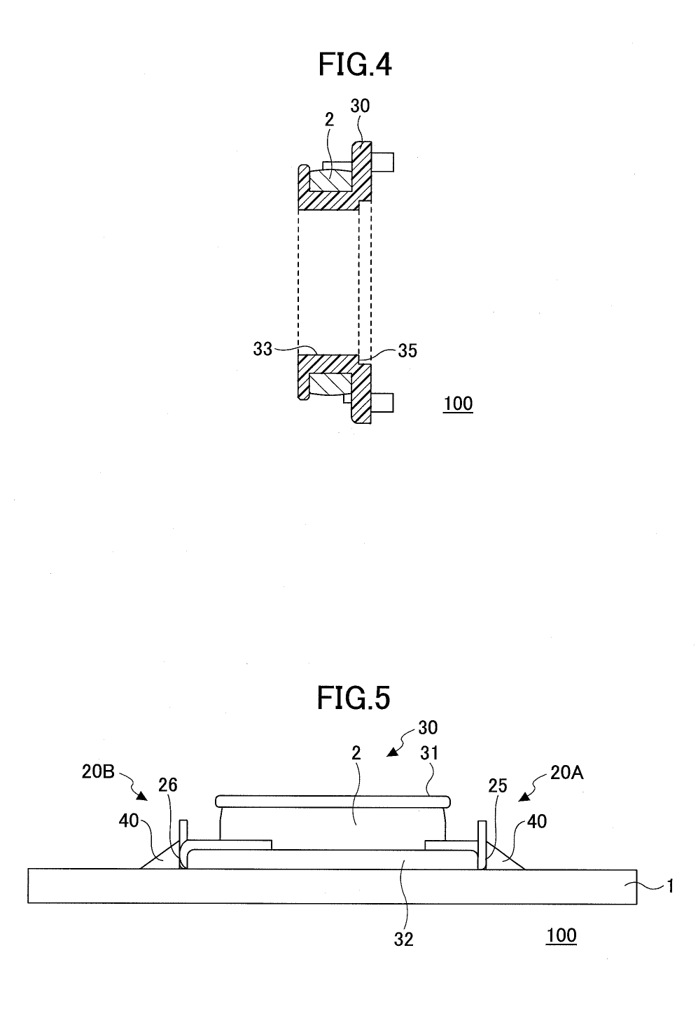

FIG. 2A and FIG. 2B are perspective views of a coil assembly 100. FIG. 2A is an upper perspective view and FIG. 2B is a lower perspective view. FIG. 3 shows a set of drawings including a front elevation view, a back elevation view, a left-side view, a right-side view, a plan view and a back plan view showing the coil assembly 100. FIG. 4 is a cross-sectional view taken along an A-A line in FIG. 3. Here, in these drawings, the core 3 as shown in FIG. 1 is not shown.

The coil assembly 100 includes a bobbin 30, a first yoke 20A and a second yoke 20B.

The bobbin 30 includes a cylindrical barrel 33, an upper flange 31 provided at an upper edge of the barrel 33, a lower flange 32 provided at a lower edge of the barrel 33, and positioning pins 34 for alignment of the bobbin 30. The coil 2 is wound around the outer periphery of the barrel 33 of the bobbin 30. The bobbin 30 may be composed of a heat-resistant resin so that it does not melt at the time of soldering, or may be composed of ceramics.

The first yoke 20A and the second yoke 20B are separately attached to the lower flange 32 of the bobbin 30 to have a space between the first yoke 20A and the second yoke 20B to form the opening 4 between the first yoke 20A and the second yoke 20B. The first yoke 20A and a second yoke 20B correspond to the first yoke 10 and the second yoke 12 of the lower yoke 10 explained above with reference to FIG. 1.

The positioning pins 34 are provided at a lower surface of the lower flange 32 to protrude from the lower surface.

The core, not shown in FIG. 2A, FIG. 2B, FIG. 3 or FIG. 4, is configured to vary the inductance of the coil 2 by being moved within the barrel 33 along a center axis of the coil 2 (a center axis of the barrel 33) in the Z-axis direction from a first side (upper side in FIGS. 2A and 2B) toward a second side (lower side in FIGS. 2A and 2B).

By using the bobbin 30, it is not necessary to compose the coil 2 by a self-welding wire. When using a self-welding wire for the coil 2, a winding process to weld the wire by heat or alcohol evaporation is necessary. However, by using the bobbin 30, it is not necessary to weld the wire itself, so that the process and cost for manufacturing the coil can be reduced.

Further, by using the bobbin 30, shock resistance can be improved compared with a case where a coil is directly attached to a yoke or a substrate. Further, for the case where the coil is directly attached to the yoke or the substrate, it is necessary to form the yoke thicker than a thickness required for a magnetic purpose in order to strengthen the structure. However, by using the bobbin 30, as the shock resistance is improved, the yoke can be formed thinner to reduce cost.

The first yoke 20A and the second yoke 20B are attached to the bobbin 30 such that the lower flange 32 of the bobbin 30 is enveloped by the first yoke 20A and the second yoke 20B from both sides in the direction perpendicular to the center axis of the coil 2.

The first yoke 20A is formed to have a U-shape composed of a lower surface portion 27 that covers a lower surface 32a (back surface) of the lower flange 32, a side surface portion 25 that covers a side surface 32b of the lower flange 32 and an upper surface portion 21 that covers an upper surface 32c (front surface) of the lower flange 32.

Similarly, the second yoke 20B is formed to have a U-shape composed of a lower surface portion 28 that covers the lower surface 32a of the lower flange 32, a side surface portion 26 that covers the side surface 32b of the lower flange 32 and an upper surface portion 22 that covers the upper surface 32c of the lower flange 32.

By providing the upper surface portion 21 of the first yoke 20A and upper surface portion 22 of the second yoke 20B, the bonding between the first yoke 20A and the second yoke 20B and the bobbin 30 can be strengthened. Further, by providing the lower surface portion 27 and the side surface portion 25 of the first yoke 20A, and the lower surface portion 28 and the side surface portion 26 of the second yoke 20B, the first yoke 20A and the second yoke 20B can function as terminals for soldering when mounting the bobbin 30 on a substrate or the like.

As shown in FIG. 5, the bobbin 30 may be mounted on a surface of a substrate 1 by the solder 40 via the lower surface portions 27 and 28 (although not shown in FIG. 5) of the first yoke 20A and the second yoke 20B, respectively. Further, as the solder 40 is also attached to the side surface portions 25 and 26 of the first yoke 20A and the second yoke 20B, respectively, wettability to solder can be improved. Therefore, the bobbin 30 can easily be mounted on and bonded to the substrate 1 by the solder 40 using a reflow oven by a Surface Mount Technology (SMT).

The first yoke 20A and the second yoke 20B may be composed of a magnetic material to which the solder can be attached. With this structure, the surface mounting of the coil assembly 100 to the substrate 1 can be easily performed.

Further, as the first yoke 20A and the second yoke 20B are formed into the U-shape by bending plates, the first yoke 20A and the second yoke 20B may be composed of a material having a good processability to press working. The material may be a steel plate to which solder plating, tin plating or the like is applied, or may be anti-corrosive martensitic stainless steel to which nickel plating is applied, for example.

As there is the space between the first yoke 20A and the second yoke 20B as described above, the first yoke 20A and the second yoke 20B are electrically not connected. Therefore, a first coil end 2d which is one end of the coil 2 may be electrically connected to the first yoke 20A and a second coil end 2e which is the other end of the coil 2 may be electrically connected to the second yoke 20B.

It means that the first yoke 20A and the second yoke 20B function as terminals for connecting the bobbin 30 to the substrate 1 by soldering and terminals to which coil ends (2d and 2e) of the coil 2 are connected, in addition to function as a magnetic purpose. Therefore, plural functions can be actualized by a single component (the first yoke 20A and the second yoke 20B), so that the number of components for the coil assembly 100 can be reduced.

For example, as shown in FIG. 2A, FIG. 2B and FIG. 3, the first yoke 20A and the second yoke 20B may further include a first terminal 23 and a second terminal 24 to which the first coil end 2d and the second coil end 2e of the coil 2 are respectively connected. With this structure, the first coil end 2d and the second coil end 2e of the coil 2 can easily be connected to the first yoke 20A and the second yoke 20B, respectively. The first coil end 2d and the second coil end 2e of the coil 2 may be connected to the first terminal 23 and the second terminal 24, respectively, by winding the respective ends (2d and 2e around the first terminal 23 and the second terminal 24, and then soldering or melting. The first terminal 23 may be formed like a lead form extending from the side surface portion 25 of the first yoke 20A in a direction parallel to the center axis of the coil 2. Similarly, the second terminal 24 may be formed like a lead form extending from the side surface portion 26 of the second yoke 20B in a direction parallel to the center axis of the coil 2.

Further, as described above, the coil assembly 100 is composed of a combination of the bobbin 30, the first yoke 20A and the second yoke 20B attached to the bobbin 30, and the first coil end 2d and the second coil end 2e of the coil 2 are respectively wound around the first terminal 23 and the second terminal 24 of the first yoke 20A and the second yoke 20B. Therefore, the coil assembly 100 can be manufactured or repaired more easily than a structure where a coil or a yoke is directly attached to a substrate without using a bobbin. For example, for the structure not using the bobbin, it is necessary to bond the coil to the yoke and then connect the ends of the coil to the substrate. Therefore, it is difficult to handle the structure when connecting the ends of the coil to the substrate in manufacturing, and further it is necessary to strip the adhesion bond between the coil and the yoke in repairing when an error occurs when connecting the ends of the coil to the substrate or the like.

However, for the coil assembly 100 of the embodiment, it is easy to mount on the substrate 1 when manufacturing, and further, it is easy to detach the coil 2 from the first terminal 23 of the first yoke 20A, the second terminal 24 of the second yoke 20B or the bobbin 30 when repairing.

Further, the lower surface portion 27 of the first yoke 20A and the lower surface portion 28 of the second yoke 20B are respectively formed to have a shape where a circular arc portion is removed as shown in FIG. 2B. With this shape, the circular opening 4 is formed at a position facing a lower end surface of a core, not shown in FIG. 2A to FIG. 5, when the first yoke 20A and the second yoke 20B are separately attached to the lower flange 32 of the bobbin 30 such that the circular arc portions are separately placed in the direction perpendicular to the center axis of the coil 2.

It means that the opening 4 is formed within the space between the first yoke 20A and the second yoke 20B to be in communication with the barrel 33 of the bobbin 30. The lower surface portion 27 of the first yoke 20A and the lower surface portion 28 of the second yoke 20B are positioned at a lower end surface side of the coil 2.

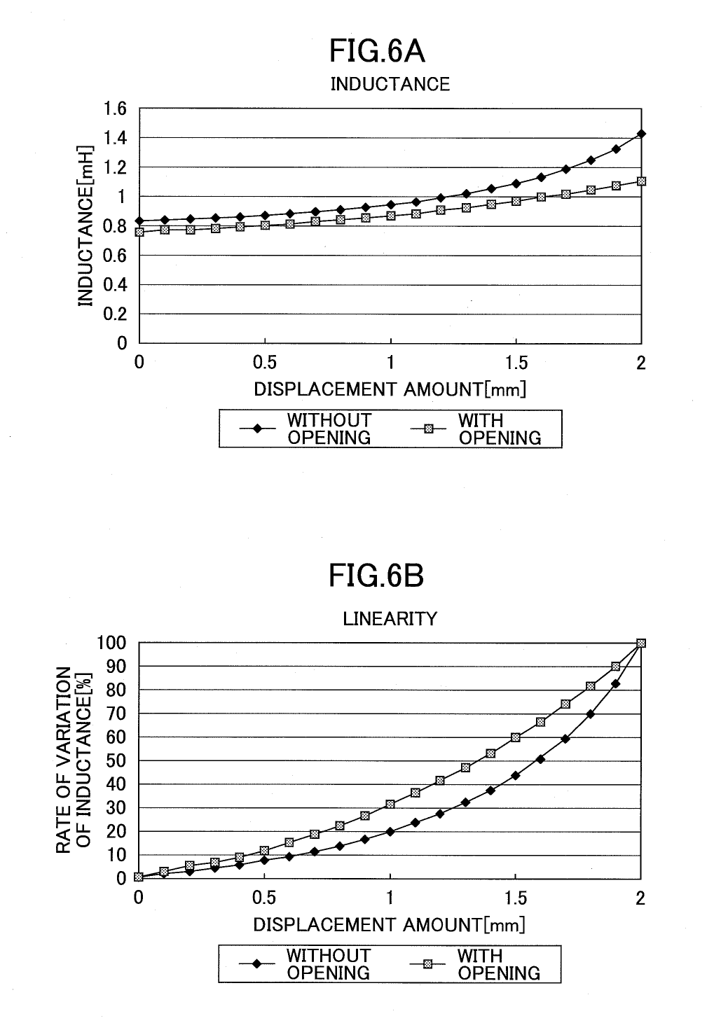

FIG. 6A is a graph showing a relationship between the detected inductance of the coil 2 with respect to the actual displacement amount of the core 3 moved downward within the coil 2, of the coil assembly 100. FIG. 6B is a graph showing the rate of variation of the detected inductance of the coil 2 with respect to the actual displacement amount of the core 3 moved downward within the coil 2.

Further, in FIGS. 6A and 6B, a graph showing a relationship between the detected inductance of a coil (or the rate of variation of the detected inductance of the coil) with respect to an actual displacement amount of a core 3 moved downward within the coil 2 of a coil assembly in which an opening such as the opening 4 as described above is not provided to a lower yoke are also shown for comparison.

The rate of variation of the detected inductance for each of the actual displacement amounts in FIG. 6B is calculated by obtaining the rate of the inductance at the respective displacement amount with respect to the maximum inductance at the maximum displacement amount (2 mm in this case) where the maximum inductance is assumed as 100.

As can be understood from FIG. 6A and FIG. 6B, when the opening 4 is provided, the linearity of the detected inductance with respect to the actual displacement amount of the core 3 is improved compared with the case where the opening is not provided.

### (Operational Detection Device)

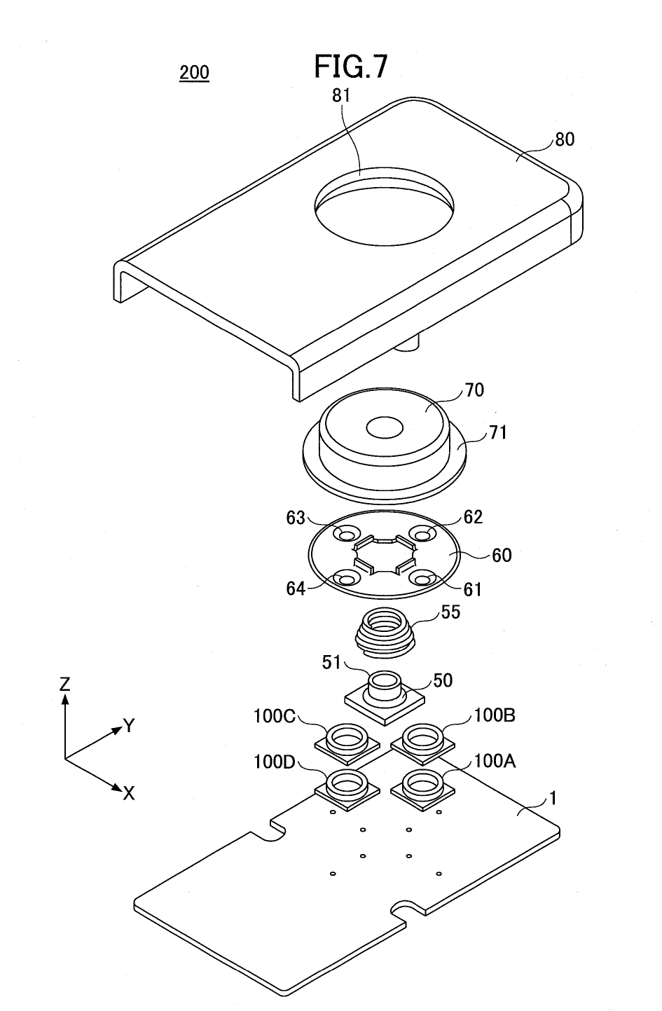

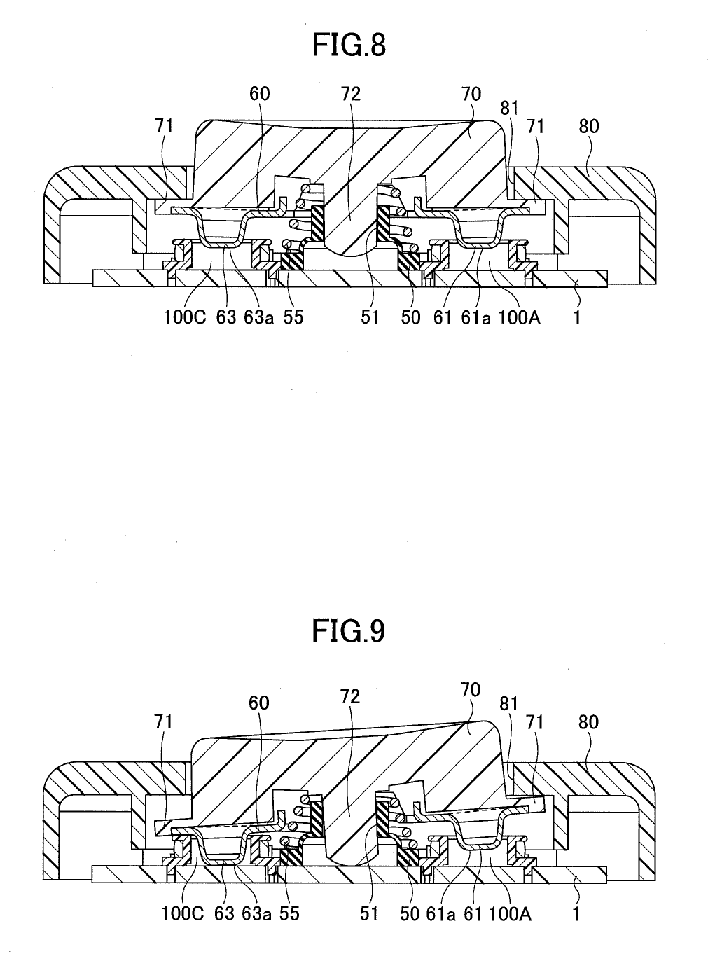

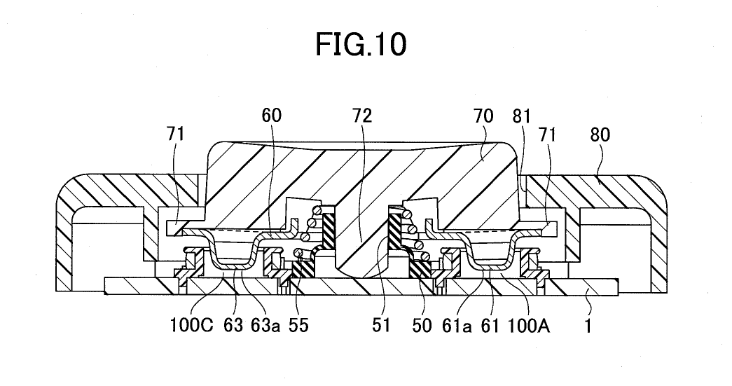

FIG. 7 is an exploded perspective view of an example of an operational detection device 200. FIG. 8, FIG. 9 and FIG. 10 are cross-sectional views of the operational detection device 200.

The operational detection device 200 is an embodiment of the operational input device.

The operational detection device 200 includes a substrate 1, plural coil assemblies (in this case, four coil assemblies 100A, 100B, 100C and 100D), plural cores (in this case, cores 61, 62, 63 and 64 respectively corresponding to the coil assemblies 100A, 100B, 100C and 100D), an upper yoke 60, a key 70, a housing 80 formed with an opening 81, a support rubber 50, and a torsion coil spring 55.

FIG. 8 shows the operational detection device 200 at an initial state where an operational input is not applied to the key 70.

Each of the four coil assemblies 100A to 100D may have the same structure and function as the coil assembly 100 described above with reference to FIG. 2A to FIG. 5.

The coil assemblies 100A to 100D are mounted on a surface of the substrate 1. The substrate 1 is a base where the surface of the substrate 1 is parallel to an X-Y plane. The substrate 1 may be composed of resin or plastic such as a FR-4 substrate, for example.

The four coil assemblies 100A to 100D may be placed on a circumference of a virtual circle having an origin O, which is a standard point of a three-dimensional orthogonal coordinate system, as a center. The coil assemblies 100A to 100D may be placed on the circumference at even intervals. With this placement, vectors of the force of the operator can easily be calculated. When the coil assemblies 100A to 100D have a same property, the coil assemblies 100A to 100D may be placed such that the distances between the centers of gravity of the adjacent coil assemblies become equal.

In this embodiment, the coil assemblies 100A to 100D are placed on the circumference at every 90° in four directions of X(+), Y(+), X(−) and Y(−) of the X-axis and the Y-axis. X(−) direction is 180° opposite from X(+) direction on the X-Y plane and Y(−) direction is 180° opposite from Y(+) direction on the X-Y plane.

The upper yoke 60 and the cores 61 to 64 are placed above the coil assemblies 100A to 100D (in other words, between the key 70 and the substrate 1). The upper yoke 60 and the cores 61 to 64 function to reinforce the inductance. The upper yoke 60 is provided with a hole formed at its center.

The key 70 includes a flange 71 and an operational shaft 72 (see FIG. 8) formed at the center of a lower surface of the key 70 to extend in the Z-axis direction. An upper surface of the key 70 functions as an operational surface to which an operator applies a force as an operational input.

The key 70 is fitted in the opening 81 of the housing 80 and held by the housing 80 in the X-axis direction and the Y-axis direction to be movable in the Z-axis direction. The flange 71 of the key 70 is pushed upward in the Z-axis direction by an initial load applied by the torsion coil spring 55 to touch an inner upper surface of the housing 80.

The support rubber 50 includes an annular hole portion 51 formed at its center to extend in the Z-axis direction. The support rubber 50 is placed on an upper surface of the substrate 1.

One end of the torsion coil spring 55 touches the center of a lower surface of the key 70 and the other end of the torsion coil spring 55 touches an upper surface of a flange of the support rubber 50. The torsion coil spring 55 penetrates the hole of the upper yoke 60.

The support rubber 50 is placed to be inserted in a hollow portion of the torsion coil spring 55. The operational shaft 72 of the key 70 penetrates the hollow portion of the torsion coil spring 55 and is supported in the annular hole portion 51 of the support rubber 50.

The upper yoke 60 is composed of a magnetic material such as a steel plate, ferrite or the like, for example, formed in a plate shape. The upper yoke 60 moves with the key 70.

The cores 61 to 64 are formed at a lower surface of the upper yoke 60. The cores 61 to 64 may be placed on a circumference of a virtual circle having an origin O, which is a standard point of a three-dimensional orthogonal coordinate system, as a center. In this embodiment, the cores 61 to 64 are formed by performing a burring process to the plate composing the upper yoke 60. The cores 61 to 64 may be composed of the same material as that which composes the upper yoke 60 or may be composed of a magnetic material different from that which composes the upper yoke 60. The cores 61 to 64 are protruding portions which move with the upper yoke 60 and the key 70 to be moved within the respective hollow portion of the four coil assemblies 100A to 100D placed below the cores 61 to 64.

The operational detection device 200 may include two or more sets of the core and the coil assembly. By providing the upper yoke 60 and the cores 61 to 64, the variation of the inductance can easily be detected and the property and performance of the operational detection device 200 as a product can be improved.

The key 70 may be composed of a resin. Alternatively, the key 70 may be composed of a magnetic material such as a plastic magnet, for example. With this, the key 70 may be configured to function as the upper yoke 60 and cores 61 to 64.

The operational detection device 200 may not include the upper yoke 60. In such a case, the cores 61 to 64 may be provided to the key 70. Even with this structure, by detecting the variation of the inductance, the movement of the key 70 can be detected.

FIG. 9 shows the operational detection device 200 when an operational input is applied such that the key 70 is inclined to have the coil assembly 100C side become lower than the coil assembly 100A side.

When a part of the key 70 corresponding to the coil assembly 100C side is pushed by an operator, the key 70 is inclined having the operational shaft 72 as a center of inclination while using the flange 71 and/or the substrate 1 as a fulcrum, the upper yoke 60 and the core 63 corresponding to the coil assembly 100C approach the coil assembly 100C so that the core 63 is inserted in the barrel 33 of the bobbin 30 of the coil assembly 100C (see FIG. 2A). With this operation, the magnetic permeability around the coil assembly 100C increases to increase the self-inductance of the coil assembly 100C. This can also happen when the key 70 is inclined other directions. Therefore, by evaluating each of the detected inductances of the four coil assemblies 100A to 100D, the inclined direction and the inclination amount of the key 70 can be detected.

FIG. 10 shows the operational detection device 200 when an operational input is applied such that the key 70 is horizontally moved downward.

When the center of the key 70 is pushed by the operator, the entirety of the key 70 moves downward in the Z-axis direction and the upper yoke 60 and the cores 61 to 64 approach the coil assemblies 100A to 100D so that all of the cores 61 to 64 are inserted in the barrels 33 of the bobbins 30 of the respective coil assemblies 100A to 100D (see FIG. 2A). With this operation, the magnetic permeability around each of the coil assemblies 100A to 100D increases to increase the self-inductances of each of the coil assemblies 100A to 100D. When the entirety of the key 70 moves downward in the Z-axis direction, the inductances of all of the coil assemblies 100A to 100D increase equally. Therefore, by evaluating each of the detected inductances of the four coil assemblies 100A to 100D, the fact that the key 70 is moved downward in the Z-axis direction and the displacement amount of the key 70 can be detected.

As described above with reference to FIG. 2A to FIG. 5, each of the coil assemblies 100A to 100D is provided with the opening 4 (see FIG. 2A, for example) formed at the portion facing the lower end surface of the respective cores 61 to 64 (for example shown as 61a and 63a in FIG. 8 to FIG. 10). As the opening 4 is provided for the first yoke 20A and the second yoke 20B of each of the coil assemblies 100A to 100D, the magnetic connection between the cores 61 to 64 and the first yoke 20A and the second yoke 20B of the respective coil assemblies 100A to 100D can be suppressed. Therefore, the linearity of the detected self-inductance of the coil 2 of each of the coil assemblies 100A to 100D with respect to the actual displacement amount of the respective cores 61 to 64 that moves with the key 70 can be improved.

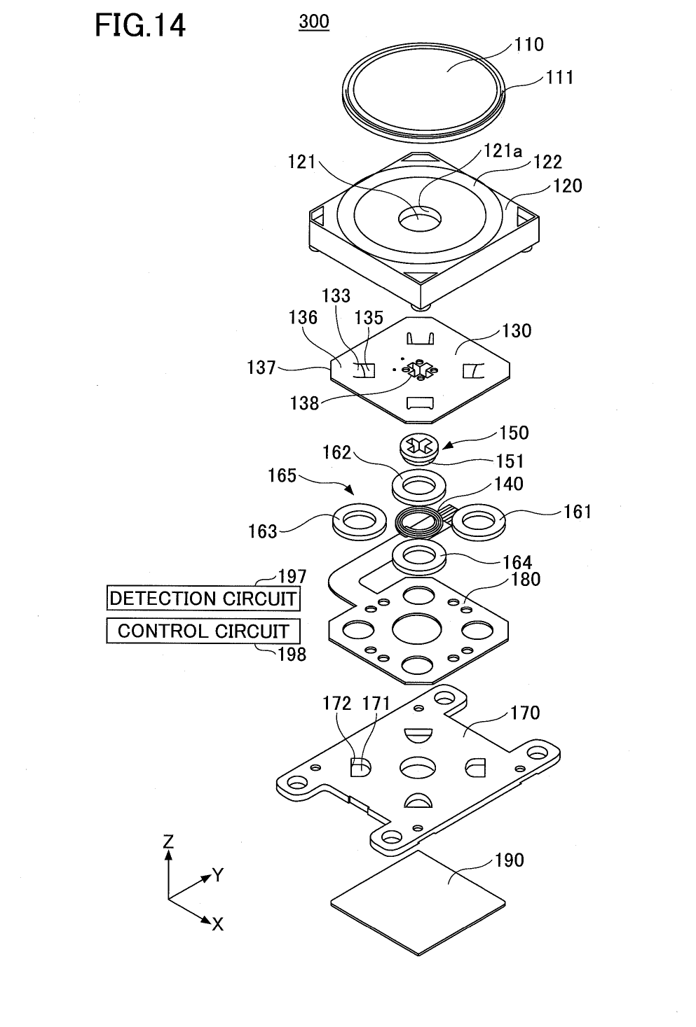

FIG. 14 is an exploded perspective view of another example of an operational input device 300.

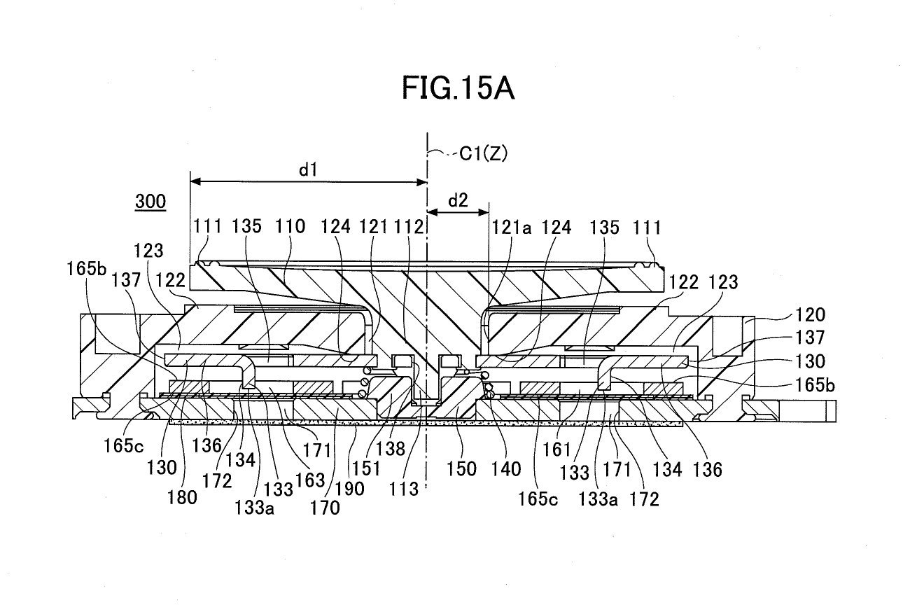

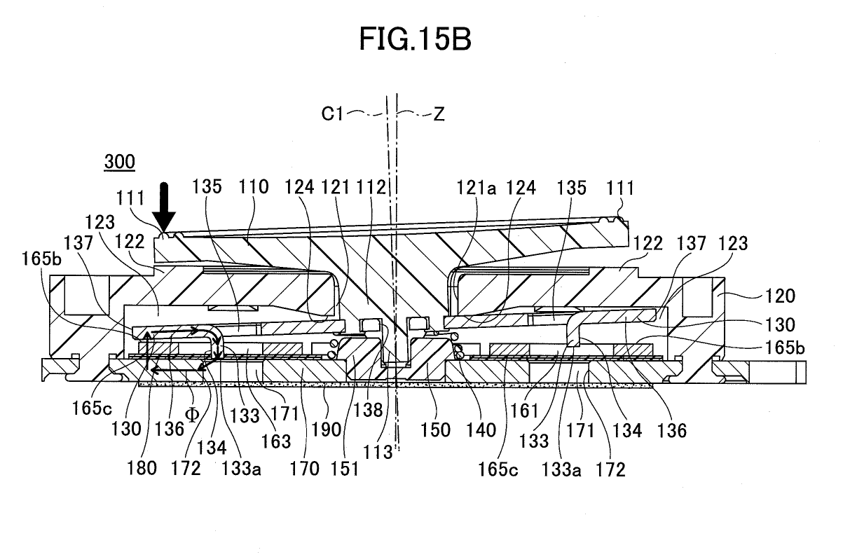

FIG. 15A is a cross-sectional view of the operational input device 300 at an initial state where an operational input is not applied to a key 110.

FIG. 15B is a cross-sectional view of the operational input device 300 when an operational input is applied to an outer edge portion 111 of the key 110 as shown by an arrow such that the key 110 is inclined to have the left-side become lower than the right-side.

The operational input device 300 includes the key 110, a housing 120, an upper yoke 130, a sensor 165, a torsion coil spring 140, a substrate 180, a lower yoke 170, a label 190, a detection circuit 197 and a control circuit 198.

The key 110 is an operational unit that is inclined by application of an operational input. The key 110 may be a direction key which is inclined at an arbitrary direction with respect to the X-Y plane by being pushed by an operational input directly or indirectly applied to an upper operational surface of the key 110, for example. The key 110 is inclined with respect to a center axis C1 that passes through the center of the key 110. When an operational input is not applied to the key 110, the center axis C1 is parallel to the Z-axis direction. The outer edge portion 111 is a periphery of the operational surface of the key 110. The operational surface of the key 110 may have a discoid form as shown in FIG. 14, or alternatively, may have a different form such as an elliptical shape, a cruciform, a polygonal shape or the like.

The housing 120 is provided with an opening portion 121 formed at its upper surface. The key 110 may be placed so that the center axis C1 becomes coaxial with a center axis of the opening portion 121 of the housing 120. The operational surface of the key 110 may be positioned at a side (upper side in FIG. 14) where the operational input is applied. Further the distance d2 between the center axis C1 of the key 110 and an inner edge 121a of the opening portion 121 may be smaller than the distance d1 between the center axis C1 and the outer edge portion 111 of the key 110. The opening portion 121 may be formed like a tubular at the upper surface of the housing 120, for example. The opening portion 121 may have a cylindrical tubular shape or an angular tubular shape.

The upper yoke 130 and the sensor 165 are placed inside the housing 120. The upper yoke 130 and the sensor 165 function as a detection unit that detects the inclination of the key 110. The upper yoke 130 functions as a first inclination detection unit that is inclined with the key 110. The sensor 165 functions as a second inclination detection unit placed to face the upper yoke 130. The sensor 165 includes plural coils (in this case, four coils 161, 162, 163 and 164).

The torsion coil spring 140 is a resilient member that pushes the key 110 toward a direction (upward in the Z-axis direction) in which the key 110 is protruded from the opening portion 121 of the housing. With this structure, the key 110 can be inclined using an inner portion 124 of the housing 120 around the opening portion 121 at the upper yoke 130 side as a fulcrum. The inner portion 124 is an annular part at the inner and upper of the housing 120. The torsion coil spring 140 is a coil spring that pushes the key 110 so that the key 110 moves back to the initial state when an operational input is not applied to the key 110.

Therefore, for the operational input device 300, the fulcrum of the key 110 when it is inclined is positioned closer to the center axis C1 than the outer edge portion 111. Thus, the amount of pushing necessary to have the key 110 inclined to a predetermined angle can be reduced compared with a structure in which the fulcrum is positioned outer side of the operational unit. Therefore, the displacement amount (stroke length) necessary for securely detecting the inclined direction of the key 110 can be shortened compared with a case where the displacement amount of the key itself is necessary to be detected. Thus, the displacement amount in the Z-axis direction for securely detecting the inclined direction of the key 110 can be shortened for the operational input device 300 compared with the structure in which the fulcrum is positioned outer side of the operational unit.

As a result, operability for moving the key 110 can be improved, and the height of the operational input device in the Z-axis direction can be lowered.

The structure of the operational input device 300 is explained in detail.

The operational input device 300 further includes an operational shaft 112 provided at the lower part of the key 110 to extend to pass through the opening portion 121 of the housing 120. The operational shaft 112 may be a column that is extended from the center of the key 110 so that a center axis of the operational shaft 112 becomes coaxial with the center axis C1 of the key 110. The operational shaft 112 moves with the key 110 and is inclined with the key 110. In other words, the key 110 is inclined by using the operational shaft 112 as a shaft and the inner portion 124 around the operational shaft 112 as the fulcrum.

The operational shaft 112 may be formed as a part of the key 110 as shown in FIG. 15A, or may be formed separately from the key 110. As the operational shaft 112 is inclined with the key 110, there may be a clearance between a side surface of the operational shaft 112 and an inner edge 121a of the housing 120 at the initial state. The operational shaft 112 may have a cylindrical column shape or an angular column shape

The upper yoke 130 is formed in a plate shape and is attached to the operational shaft 112 like a flange. The upper yoke 130 is used for detecting the inclination of the key 110. As will be explained later in detail, the upper yoke 130 is provided with the plural cores.

The upper yoke 130 may be directly attached to the operational shaft 112, or attached to the operational shaft 112 via a predetermined member. The upper yoke 130 may be attached to a center edge portion 113 of the operational shaft 112, or may be attached to a middle part of the operational shaft 112 between the lower center portion of the key 110 and the center edge portion 113. The upper yoke 130 moves with the operational shaft 112 and is inclined with the operational shaft 112 (it means that the upper yoke 130 is inclined with the key 110). The upper yoke 130 may have a polygonal shape such as a rectangular shape as shown in FIG. 14 or may have a circular shape.

The sensor 165 detects the inclination of the key 110. The sensor 165 may be an element that measures the displacement amount of the key 110 in the Z-axis direction and outputs an analog signal that varies in accordance with the displacement amount of the key 110 in the Z-axis direction to the detection circuit 197, for example.

The detection circuit 197 may include an AD converter that detects the analog signal output from the sensor 160 and supply data converted by the AD converter based on the analog signal as detection data corresponding to the displacement amount of the key 110 to the control circuit 198, for example.

The detection circuit 197 and/or the control circuit 198 may be mounted on the substrate 180 on which the sensor 165 is also mounted, or may be mounted on another substrate connected to the substrate 180. The substrate 180 may be a flexible printed substrate (FPC), a FR-4 substrate, a ceramic substrate, or other kind of substrate.

The sensor 165 may be an element that outputs an analog signal which varies in accordance with the positional relationship between the sensor 165 and the upper yoke 130 (cores), for example. When the sensor 165 is such an element, by placing the sensor 165 so that the distance between the sensor 165 and the upper yoke 130 varies in accordance with the displacement amount of the key 110, the displacement amount of the key 110 can be contactlessly measured.

The sensor 165 may include a coil whose self-inductance varies in accordance with the displacement amount of the key 110 in order to contactlessly measure the displacement amount of the key 110, for example. In this case, the sensor 165 detects the variation of the self-inductance of the coil as the displacement amount of the key 110. By fixing the coil at a position facing the upper yoke 130 (core), the self-inductance of the coil can easily be varied because the magnetic permeability around the coil varies in accordance with the displacement amount of the key 110, for example.

The detection circuit 197 detects a physical value of the sensor 165 that equivalently varies in accordance with the variation of the self-inductance of the coil based on the analog signal output from the sensor 165. Then, the detection circuit 197 supplies the detected physical value as detection data corresponding to the displacement amount of the key 110 to the control circuit 198.

The detection circuit 197 supplies a pulse signal to the coil of the sensor 165 to have the sensor 165 generate the physical value and output the analog signal including the physical value.

For the operational input device 300, the four coils 161 to 164 may be placed on a circumference of a virtual circle having an origin O, which is a standard point of a three-dimensional orthogonal coordinate system, as a center. By measuring the displacement amount of the key 110 by the plural coils 161 to 164 placed at the positions different from each other, the pushed position of the key 110 by the operational input (in other words, inclined direction of the key 110) can be detected. In this embodiment, the coils 161 to 164 are placed on the circumference at every 90° in four directions of 45° between the X-axis and the Y-axis in the X-Y plane. Alternatively, the coils 161 to 164 may be placed on the circumference at every 90° in four directions of X(+), Y(+), X(−) and Y(−) of X-axis and Y-axis.

The control circuit 198 sends a control signal to a host to move an object shown on a screen of a display to a direction of the pushed position of the key 110 detected by the sensor 165 and the detection circuit 197. The control circuit 198 includes a microcomputer including a central processing unit (CPU), for example.

The torsion coil spring 140 supports the key 110 and the upper yoke 130 such that these are inclinable with having the inner portion 124 of the housing 120, which is positioned between the center axis C1 and the outer edge portion 111, as a fulcrum. When an operational input is not applied to the key 110, the torsion coil spring 140 supports the key 110 and the upper yoke 130 such that the upper yoke 130 contacts the inner portion 124 of the housing 120. An upper end of the torsion coil spring 140 contacts a lower surface at the center portion of the upper yoke 130 and the lower end of the torsion coil spring 140 contacts an upper surface at the center portion of the lower yoke 170 through an opening at the center portion of the substrate 180.

The lower yoke 170 is formed in a plate shape. The lower yoke 170 functions to increase the absolute value of the self-inductances of the coils 161 to 164.

The label 190 is a sheet provided at a lower surface of the lower yoke 170 for bonding the operational input device 300 to a surface of a substrate or the like.

The lower yoke 170 may be composed of a material whose relative magnetic permeability is greater than 1. The lower yoke 170 may be composed of a material whose relative magnetic permeability is greater than or equal to 1.001. Concretely, the material may be a soft magnetic material such as ferrum or an alloy of ferrum such as steel (the relative magnetic permeability of ferrum is 5000). The lower yoke 170 may be composed of a steel plate, for example.

The housing 120 is configured to include a space 123 at portions facing the upper surface of the upper yoke 130 so that the upper yoke 130 does not touch the inner upper surface of the housing 120 even when it is inclined. The space 123 may be provided at the outer of the inner portion 124 of the inner upper surface of the housing 120.

The operational input device 300 further includes a stopper 122 provided to the housing 120 to limit the moving range of the key 110.

The stopper 122 is provided to face the outer edge portion 111 of the key 110. The stopper 122 is a cylindrically protruding portion formed at the upper surface of the housing 120. When the key 110 is pushed downward, the outer edge portion 111 of the key 110 touches the stopper 122 so that the key 110 cannot be further moved. By providing the stopper 122, even when the key 110 is moved to a full displacement range, the deformation of the key 110 or the housing 120 can be suppressed so that the stress applied to the components of the operational input device 300 can be reduced. As a result, the operational input device 300 can be strengthened to reduce an error in detection of the displacement amount because of the deformation of components. The variance of the displacement amounts in 360° directions can be reduced.

The operational input device 300 further includes a rotation stopper 150 to prohibit the rotation of the key 110.

The rotation stopper 150 prohibits the rotation of the key 110 and the upper yoke 130 around the center axis C1. The rotation stopper 150 is fixed to face the center edge portion 113 of the operational shaft 112. The rotation stopper 150 may be fixed in the lower yoke 170 as shown in FIG. 15A, or alternatively, may be fixed to the substrate 180. Clearances are provided between the rotation stopper 150 and the center edge portion 113 of the operational shaft 112 in the X-axis direction, the Y-axis direction and the Z-axis direction to ease the inclination of the key 110 and the upper yoke 130 using the inner portion 124 of the housing 120 as a fulcrum. The rotation stopper 150 may be formed to function as a stopper to limit the moving range of the key 110 as the stopper 122.

The rotation stopper 150 includes a receiving portion 151 capable of fitting with the center edge portion 113 of the operational shaft 112 to prohibit the rotation of the key 110 and the upper yoke 130 around the center axis C1. There may be clearances between the receiving portion 151 and the center edge portion 113 in the X-axis direction, the Y-axis direction and the Z-axis direction to ease the inclination of the key 110 and the upper yoke 130 using the inner portion 124 of the housing 120 as a fulcrum at a state where the rotation of the key 110 and the upper yoke 130 is not prohibited by the receiving portion 151.

The upper yoke 130 is formed in a plate shape and is composed of a magnetic material such as a steel plate or ferrite, for example. The upper yoke 130 moves with the key 110.

The upper yoke 130 is provided with plural cut and bent portions 133, which function as cores, formed at its lower surface. The cut and bent portions 133 are placed on a circumference of a virtual circle having an origin O in the X-Y plane.

The cut and bent portion 133 are formed by cutting the plate shape upper yoke 130 while leaving plural base portions 136 and bending the cut portions from the respective base portions 136 downward to form the plural holes 135. The four cut and bent portions 133 are protruding portions to move with the upper yoke 130 and the key 110 and move within the four coils 161 to 164 placed below the cut and bent portions 133 in the Z-axis direction. By providing the upper yoke 130 and the cut and bent portions 133, the variation of the inductance can be easily detected and the property and performance of the operational input device 300 as a product can be improved.

The lower yoke 170 is placed at a lower end surfaces 165c side of the coils 161 to 164. The lower yoke 170 is provided with four openings 171 respectively facing lower ends 133a of the four cut and bent portions 133. Each of the openings 171 may be formed to have a size large enough so that the respective cut and bent portions 133 are capable of being inserted and do not touch.

By forming the openings 171, the magnetic connection between the lower yoke 170 (other than the openings 171) and the cut and bent portions 133 can be suppressed. With this, the linearity of the detected self-inductance of each of the coils 161 to 164 with respect to the displacement amount of the respective cut and bent portions 133 (cores) that moves with the key 110 can be improved.

As shown in FIG. 15B, even when the upper yoke 130 is inclined to the maximum angle within the movable range, there exists a gap through which a magnetic flux Φ can pass between a side surface 134 of the cut and bent portions 133 and a side surface 172 of the lower yoke 170. With this, the linearity of the detected self-inductance of each of the coils 161 to 164 can be improved.

The openings 171 may be formed to be a semicircular shape or a semielliptical shape so that the side surface 172 becomes parallel to the side surface 134 of the cut and bent portion 133. With this, the linearity of the detected self-inductance of each of the coils 161 to 164 can be further improved.

Further, the cut and bent portions 133 are formed such that the base portions 136 are positioned at a peripheral portion 137 side of the upper yoke 130 than the holes 135. As shown in FIG. 14, in this embodiment, the base portions 136 are positioned closer to the corner of the peripheral portion 137 than the holes 135. It means that the hole 135 is formed such that the base portion 136 (or the cut and bent portions 133) is positioned at the peripheral portion 137 side where the displacement amount becomes larger than the center portion 138 side of the upper yoke 130. Therefore, the sensitivity to detect the variation of the self-inductances of the coils 161 to 164 can be increased. The cut and bent portions 133 may be provided such that each of the base portions 136 faces the cylindrical upper surface 165b of the respective coils 161 to 164. With this structure, the sensitivity to detect the variation of the self-inductances of the coils 161 to 164 can be further increased.

Alternative examples of the embodiment are explained.

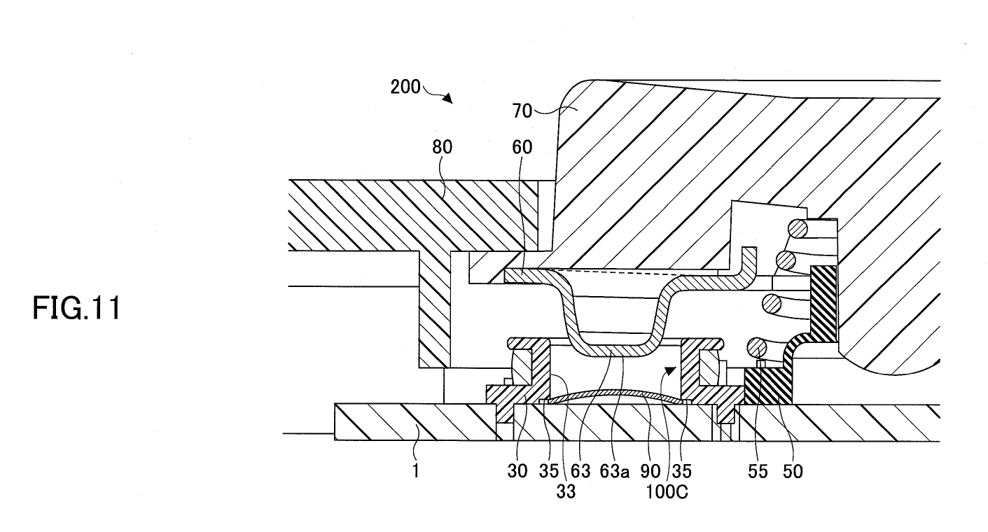

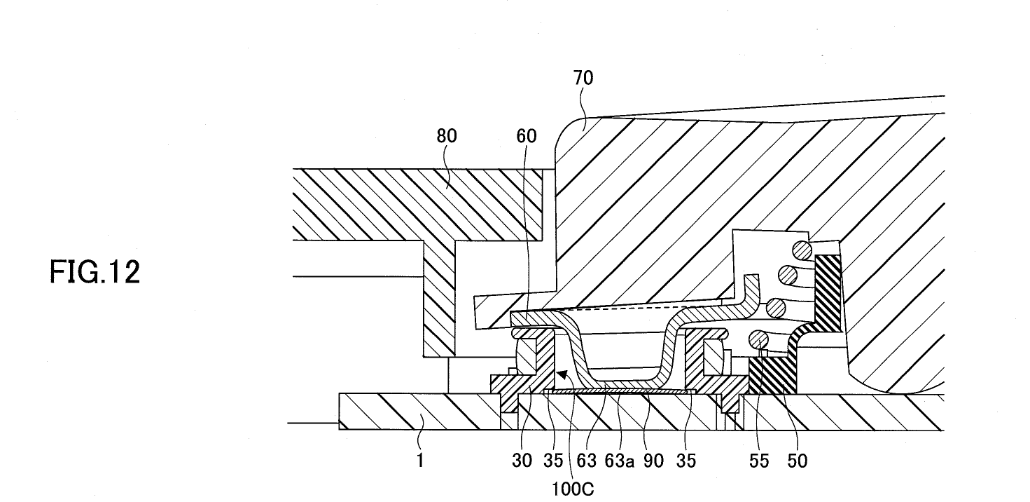

As shown in FIG. 11 and FIG. 12, the operational detection device 200 explained above with reference to FIG. 7 to FIG. 10, may further include a click spring 90 provided on the substrate 1 between the barrel 33 of the bobbin 30 of each of the coil assemblies 100A to 100D, for example.

In this case, as shown in FIG. 3, FIG. 4, FIG. 11 and FIG. 12, the barrel 33 of the bobbin 30 may be formed to have a step portion 35 at the peripheral portion of the lower end at the substrate 1 side so that the peripheral portion of the click spring 90 is inserted between the substrate 1 and the step portion 35 of the bobbin 30 to be fixed. By providing the step portion 35, the click spring 90 can be fixed by the barrel 33 of the bobbin 30. Therefore, it is not necessary to additionally provide a film to fix the click spring 90 such as a laminated film or the like. As a result, the numbers of components can be reduced and manufacturing of the operational detection device 200 can be simplified.

FIG. 11 is an enlarged cross-sectional view of the operational detection device 200 showing a part of the operational detection device 200 including the click spring 90 at an initial state when an operational input is not applied. FIG. 12 is an enlarged cross-sectional view of the operational detection device 200 showing a part of the operational detection device 200 including the click spring 90 when an operational input is applied such that the key 70 is inclined to have the coil assembly 100C side become lower than the coil assembly 100A side (not shown in FIG. 12, see FIG. 9).

The length of the cores 61 to 64 in the Z-axis direction may be long enough to completely push the click spring when the key 70 is inclined (in other words, long enough to have the click spring being clicked). Further, an elastic material such as a rubber or the like may be provided at a front center edge of each of the cores 61 to 64 (at a position to be in contact with the click spring 90). With this, feeling at clicking can be moderated. Further, a resin material may be provided at the front center edge of each of the cores 61 to 64. With this, a friction between each of the cores 61 to 64 and the respective the click spring 90 when contacting the click spring 90 can be reduced.

As shown in FIG. 12, when the key 70 is inclined, the upper yoke 60 moves downward with the core 63 and the inductance of the coil assembly 100C positioned below the core 63 increases. When the key 70 is further inclined, the front edge of the core 63 touches the click spring 90 to deform the click spring 90 so that an operator operating the key 70 can feel a click.

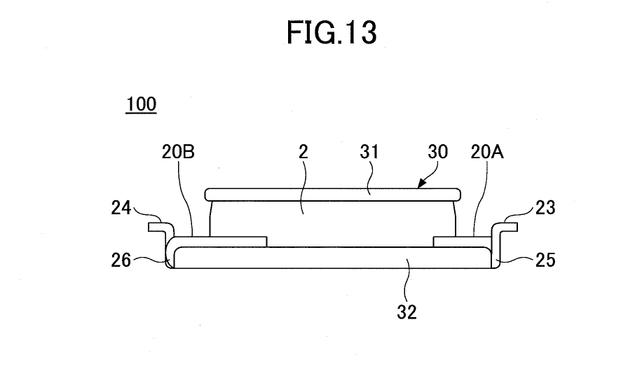

Further, FIG. 13 is a front elevation view showing another example of the coil assembly 100 shown in FIG. 2A. As shown in FIG. 13, the first terminal 23 and the second terminal 24 may be bent to extend in the direction perpendicular to the center axis of the coil 2. With this structure, the positions of the first terminal 23 and the second terminal 24 become further from the bobbin 30. Therefore, it becomes easier to wind the coil 2 to the first terminal 23 and the second terminal 24 by a winding apparatus when manufacturing the coil assembly 100.

Further, the operational input device of the embodiment may be configured to be operated by a palm, a toe or a sole, not limited to a hand or fingers. Further, the operational surface of the key of the operational input device that an operator touches may be a flat surface, a concaving surface or a convex surface.

The present invention is not limited to the specifically disclosed embodiments, and variations and modifications may be made without departing from the scope of the present invention.

The present application is based on Japanese Priority Application No. 2011-027918 filed on Feb. 10, 2011, and Japanese Priority Application No. 2012-012488 filed on Jan. 24, 2012 the entire contents of which are hereby incorporated herein by reference.

What is claimed is:

1. An operational input device that outputs a signal corresponding to a displacement amount of an operational input, comprising:
a coil annularly extending from a first side toward a second side;
a core configured to vary the inductance of the coil by being moved within the coil along an axis of the coil by the operational input applied from the first side toward the second side; and
a yoke provided at an end surface of the coil at the second side and provided with an opening at a position facing an end surface of the core at the second side.

2. The operational input device according to claim 1,
wherein the opening of the yoke is formed to be larger than the dimension of the end surface of the core at the second side.

3. The operational input device according to claim 1,
wherein the yoke is composed of a first yoke and a second yoke separately provided to have a space between the first yoke and the second yoke, and the opening is provided between the first yoke and the second yoke.

4. The operational input device according to claim 3,
wherein the first yoke and the second yoke are composed of a electrically conductive material, and
one end of the coil is electrically connected to the first yoke and the other end of the coil is electrically connected to the second yoke.

5. The operational input device according to claim 4,
wherein the first yoke includes a first terminal to which the one end of the coil is wound and
the second yoke includes a second terminal to which the other end of the coil is wound.

6. The operational input device according to claim 1, further comprising:
a bobbin including a barrel to which the coil is wound and within which the core is moved along the axis of the coil and
the yoke is provided at an end of the bobbin at the second side.

7. The operational input device according to claim 6,
wherein the bobbin includes a flange provided at an end of the barrel at the second side, and
the yoke is provided to cover the flange at a front surface at the first side, a back surface at the second side and a side surface between the front surface and the back surface.

8. The operational input device according to claim 7,
wherein the yoke is formed by bending to cover the front surface, the back surface and the side surface of the flange.

9. The operational input device according to claim 7,
wherein the yoke is composed of a material having a wettability to solder.

10. The operational input device according to claim 1,
wherein the yoke is composed of a material having a wettability to solder.

11. The operational input device according to claim 6, further comprising:
a click spring provided at an end of the barrel at the second side to be pushed by the core when the core is moved from the first side toward the second side within the coil barrel along the axis of the coil, and
wherein the barrel is provided with a step portion at the second side to fix the click spring between a substrate on which the bobbin is mounted.

12. The operational input device according to claim 1, further comprising:
an upper yoke plate provided at the first side of the coil, and
wherein the core is composed by a protruding portion formed at the upper yoke plate to protrude toward the second side.

13. The operational input device according to claim 12,
wherein the protruding portion is formed by cutting a part of the upper yoke plate to leave a base portion and bending the part at the base portion toward the second side.

14. The operational input device according to claim 13, further comprising:
a key including
an operational surface to which the operational input is applied and is provided at the first side of the upper yoke plate and
an operational shaft provided at a center of the operational surface having an axis different from the axis of the coil to extend from the first side toward the second side,
wherein the operational input is applied to the core having the operational shaft as a center of inclination, and
the protruding portion of the upper yoke plate is formed such that the base portion positions further from the axis of the operational shaft than the cut part.
